(19) United States
(12) Patent Application Publication
(10) Pub. No.: US 2017/0032758 A1
(43) Pub. Date: Feb. 2, 2017

(54) GAMMA REFERENCE VOLTAGE GENERATOR AND DISPLAY DEVICE HAVING THE SAME

(71) Applicant: Samsung Display Co., Ltd., Yongin-si (KR)

(72) Inventors: Min Ho PARK, Yongin-si (KR); Kyun Ho KIM, Yongin-si (KR); Sung In KANG, Yongin-si (KR); Yang Uk NAM, Yongin-si (KR); Yoon Sik PARK, Yongin-si (KR)

(21) Appl. No.: 15/158,542

(22) Filed: May 18, 2016

(30) Foreign Application Priority Data
Jul. 31, 2015 (KR) 10-2015-0108616

(51) Int. Cl. G09G 3/36; G09G 3/20

(52) U.S. Cl. CPC G09G 3/3688; G09G 3/2003; G09G 2300/0426; G09G 2310/0291; G09G 2310/08; G09G 2320/0673

(57) ABSTRACT

A gamma reference voltage generator includes first and second resistors between a base voltage source and an input node, a third resistor coupled to a first node between the first resistor and the second resistor, a first transistor coupled to the input node and coupled to a first output node, a fourth resistor coupled between the first transistor and the input node, an operational amplifier coupled to the first node and coupled to a second terminal of the third resistor, a second transistor coupled to the first transistor, coupled to the second terminal of the third resistor and a second output node, and coupled to an output terminal of the operational amplifier, a fifth resistor and a first capacitor coupled in parallel between the second output node and the base voltage source, and a plurality of resistors coupled between the first output node and the second output node.

### CROSS-REFERENCE TO RELATED APPLICATION

This application claims priority to, and the benefit of, Korean Patent Application No. 10-2015-0108616, filed on Jul. 31, 2015, in the Korean Intellectual Property Office, the entire content of which is incorporated herein by reference.

### BACKGROUND

1. Field

Embodiments of the present invention relate to a gamma reference voltage generator capable of reducing noise of power voltage, and thus capable of generating stable gamma reference voltage, and a display device having the same.

2. Description of the Related Art

A display device generates a power voltage using an input voltage. The power voltage is either used as a source voltage to drive circuit elements, or used to generate a gamma reference voltage and the like.

For example, but without limitation thereto, a liquid crystal display (LCD) device boosts an input voltage Vin to generate a high potential power voltage AVDD, and uses the power voltage AVDD to generate gamma reference voltages, gate driving voltages, and/or a common voltage. The power voltage AVDD can also be used as a source voltage to drive an output buffer of a data driver.

### SUMMARY

Embodiments of the present invention relate to a gamma reference voltage generator capable of eliminating noise from power voltage, and is thus capable of generating stable gamma reference voltage.

In an embodiment, a gamma reference voltage generator includes a first resistor and a second resistor coupled in series between a base voltage source and an input node for receiving a power voltage, a third resistor including a first terminal coupled to a first node between the first resistor and the second resistor, a first transistor including a first electrode coupled to the input node, a second electrode coupled to a first output node, and a gate electrode, a fourth resistor coupled between the gate electrode of the first transistor and the input node, an operational amplifier including a first input terminal coupled to the first node, a second input terminal coupled to a second terminal of the third resistor, and an output terminal, a second transistor including a first electrode coupled to the gate electrode of the first transistor, a second electrode coupled to the second terminal of the third resistor and to a second output node, and a gate electrode coupled to the output terminal of the operational amplifier, a fifth resistor and a first capacitor coupled in parallel between the second output node and the base voltage source, and a plurality of resistors coupled between the first output node and the second output node.

The plurality of resistors may include a sixth resistor coupled between the first output node and a third output node, a seventh resistor coupled between the third output node and a fourth output node, and an eighth resistor coupled between the fourth output node and the second output node.

The gamma reference voltage generator may further include a second capacitor coupled between the first output node and the base voltage source, a third capacitor coupled between the third output node and the base voltage source, and a fourth capacitor coupled between the fourth output node and the base voltage source.

The gamma reference voltage generator may further include a ninth resistor coupled between the input node and the first electrode of the first transistor.

The first input terminal and the second input terminal of the operational amplifier may include a non-inverting input terminal and an inverting input terminal, respectively, and the second transistor may include a N-type transistor.

The first transistor may include a N-type transistor.

The first output node may include a node through which a gamma reference voltage including a highest voltage among a plurality of gamma reference voltages is configured to be output, and the second output node may include a node through which a gamma reference voltage including a lowest voltage among the plurality of gamma reference voltages is configured to be output.

In an embodiment, a display device includes a gamma reference voltage generator configured to generate a plurality of gamma reference voltages using a power voltage, a data driver configured to generate data signals using the gamma reference voltages, and a display panel configured to display images corresponding to the data signals, wherein the gamma reference voltage generator includes a first resistor and a second resistor coupled in series between a base voltage source and an input node for receiving a power voltage, a third resistor including a first terminal coupled to a first node between the first resistor and the second resistor, a first transistor including a first electrode coupled to the input node, a second electrode coupled to a first output node, and a gate electrode, a fourth resistor coupled between the gate electrode of the first transistor and the input node, an operational amplifier including a first input terminal coupled to the first node, a second input terminal coupled to a second terminal of the third resistor, and an output terminal, a second transistor including a first electrode coupled to the gate electrode of the first transistor, a second electrode coupled to the second terminal of the third resistor and to a second output node, and a gate electrode coupled to the output terminal of the operational amplifier, a fifth resistor and a first capacitor coupled in parallel between the second output node and the base voltage source, and a plurality of resistors coupled between the first output node and the second output node.

The plurality of resistors may include a sixth resistor coupled between the first output node and a third output node, a seventh resistor coupled between the third output node and a fourth output node, and an eighth resistor coupled between the fourth output node and the second output node.

The gamma reference voltage generator may further include a second capacitor coupled between the first output node and the base voltage source, a third capacitor coupled between the third output node and the base voltage source, and a fourth capacitor coupled between the fourth output node and the base voltage source.

The gamma reference voltage generator may further include a ninth resistor coupled between the input node and the first electrode of the first transistor.

The first transistor and the second transistor may include N-type transistors.

### BRIEF DESCRIPTION OF THE DRAWINGS

Example embodiments will now be described more fully hereinafter with reference to the accompanying drawings, in which:

FIG. 1 is a block diagram illustrating a display device in accordance with an embodiment;

FIG. 2 is a circuit diagram illustrating a gamma reference voltage generator in accordance with an embodiment; and

FIG. 3 is a waveform diagram illustrating input/output waveforms of the gamma reference voltage generator shown in FIG. 2.

### DETAILED DESCRIPTION

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

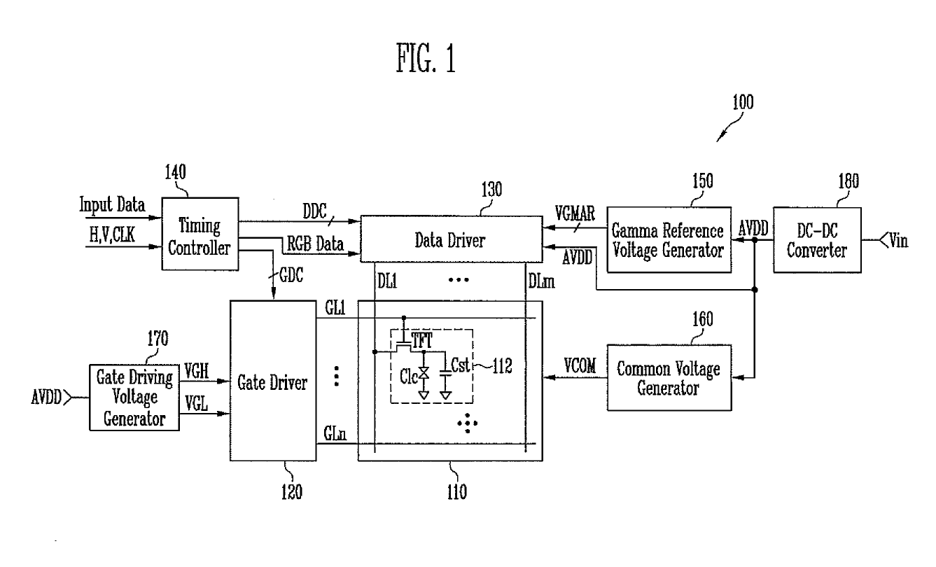

FIG. 1 is a block diagram illustrating a display device in accordance with an embodiment. Although the display device of the present embodiment is described as a liquid crystal display device, the display device is not limited thereto, and may also be a different type of display device, including an organic light emitting display device as well.

Referring to FIG. 1, a display device 100 in accordance with an embodiment may include a liquid crystal display (LCD) panel 110, a gate driver 120 and a data driver 130 for driving the LCD panel 110, a timing controller 140 for controlling the gate driver 120 and the data driver 130. The display device 100 may also include a gamma reference voltage generator 150, a common voltage generator 160, and a gate driving voltage generator 170 for respectively generating a gamma reference voltage VGMAR, a common voltage VCOM, and gate driving voltages VGH and VGL, and a DC-DC converter 180 for generating a power voltage AVDD using an input voltage Vin.

In the present embodiment, the gate driver 120 and the data driver 130 are shown as separate from the LCD panel 110, although the gate driver 120 and/or the data driver 130 may be included in the LCD panel 110 in other embodiments.

Furthermore, in a display device that is different than the LCD device, the LCD panel 110 may be replaced with a different type of display panel, such as an organic light emitting display panel and the like.

The LCD panel 110 may include two glass substrates with a liquid crystal layer injected therebetween. The LCD panel 110 may include multiple gate lines GL1 to GLn, multiple data lines D1 to Dm, and multiple pixels 112 respectively formed at crossing sections of the gate lines GL1 to GLn and the data lines D1 to Dm.

Each pixel may include a thin film transistor TFT coupled to a gate line GL and to a data line DL arranged on corresponding horizontal and vertical lines, and may include a liquid crystal capacitor Clc and a storage capacitor Cst coupled to the thin film transistor TFT.

A gate electrode of the thin film transistor TFT may be coupled to the gate line GL, and a first electrode of the thin film transistor TFT may be coupled to the data line DL. A second electrode of the thin film transistor TFT may be coupled to a pixel electrode of a liquid crystal cell (or a liquid crystal capacitor) Clc and also coupled to an electrode of the storage capacitor Cst. The thin film transistor TFT may be turned on in response to a gate signal (a scan signal) supplied to the gate line GL.

When the thin film transistor TFT is turned on, a data signal supplied to the data line DL may be supplied to the pixel electrode of the liquid crystal cell Clc. Here, the common voltage Vcom may be supplied to a common electrode of the liquid crystal cell Clc. Therefore, as the arrangement of liquid crystals of the liquid crystal cell Clc is changed by an electric field between the pixel electrode and the common electrode, release of incident light supplied from a back light may be controlled. As a result, a gray scale or a tone corresponding to the data signals may be expressed.

A data signal supplied via the thin film transistor TFT may be stored in the storage capacitor Cst. The storage capacitor Cst may be coupled between the second electrode of the thin film transistor TFT and the common electrode, or, between the second electrode of the thin film transistor TFT and a gate line of a previous stage and the like. The storage capacitor Cst may keep the voltage of the liquid crystal cell Clc constant until a data signal of the next frame is supplied.

The LCD panel 110 may, in response to a gate signal supplied from the gate driver 120, receive a data signal from the data driver 130, and may display an image corresponding to the data signal.

The gate driver 120 may generate gate signals in order in response to a gate driving control signal GDC supplied from the timing controller 140. Gate signal generated in the gate driver 120 may be supplied to the gate lines GL1 to GLn in order. High-level and low-level voltages of a gate signal may be determined by a gate high voltage VGH and a gate low voltage VGL supplied from the gate driving voltage generator 170.

The data driver 130 may generate data signals in response to a data driving control signal DDC and image data RGB Data supplied from the timing controller 140. For example, the data driver 130 may generate data signals by sampling and latching digital image data RGB Data, and by converting the digital image data RGB Data into an analog data voltage capable of expressing a gray scale in the liquid crystal cells Clc.

The data driver 130 may convert the digital image data RGB Data into a data signal in the form of an analog gray scale voltage using a plurality of gamma reference voltages VGMAR supplied from the gamma reference voltage generator 150.

Gamma reference voltages may include at least a high gamma reference voltage and a low gamma reference voltage used in generating data signals, and may further include at least one middle gamma reference voltage with a value between those of the high and low gamma reference voltages. For example, gamma reference voltages VGMAR include a positive high gamma reference voltage (hereinafter referred to as the “UH (upper-high) gamma reference voltage”) with the highest voltage, a negative low gamma reference voltage (hereinafter referred to as the “LL (lower-low) gamma reference voltage”) with the lowest voltage. The gamma reference voltages VGMAR may further include a positive low gamma reference voltage (hereinafter referred to as the “UL (upper-low) gamma reference voltage”) and a negative high gamma reference voltage (hereinafter referred to as the “LH (lower-high) gamma reference voltage”) with values between the UH gamma reference voltage and the LL gamma reference voltage. The gamma reference voltages VGMAR may be a reference voltage for a brightness curve of the LCD panel 110.

A data signal converted into an analog gray scale voltage may be supplied to the data lines DL1 to DLm via an output buffer included in the data driver 130.

The timing controller 140 may arrange externally supplied input data, and may supply the image data RGB Data to the data driver 130. Also, the timing controller 140 may generate the gate driving control signal GDC and the data driving control signal DDC using control signals, such as horizontal/vertical synchronization signals H and V, clock signals CLK, etc., and may respectively supply the gate driving control signal GDC and the data driving control signal DDC to the gate driver 120 and the data driver 130.

The gamma reference voltage generator 150 may be supplied with the power voltage AVDD from the DC-DC converter 180, and may generate a plurality of gamma reference voltages VGMAR using the power voltage AVDD.

For example, the plurality of gamma reference voltages VGMAR may be the previously described gamma reference voltages UH, UL, LH, and LL.

The plurality of gamma reference voltages VGMAR generated in the gamma reference voltage generator 150 may be supplied to the data driver 130. The gamma reference voltages VGMAR may be used as reference voltages when a digital-analog converter DAC included in the data driver 130 generates an analog gray scale voltage using digital data.

The common voltage generator 160 may receive the power voltage AVDD from the DC-DC converter 180, and may generate the common voltage VCOM using the power voltage AVDD. The common voltage VCOM generated in the common voltage generator 160 may be supplied to the common electrode of the liquid crystal cells Clc of the pixels 112.

The gate driving voltage generator 170 may be supplied with the power voltage AVDD from the DC-DC converter 180, and may generate a gate high voltage VGH and a gate low voltage VGL using the power voltage AVDD. The gate high voltage VGH and the gate low voltage VGL generated in the gate driving voltage generator 170 may be supplied to the gate driver 120.

The gate high voltage VGH may be a voltage that is equal to, or greater than, a threshold voltage of the thin film transistor TFT included in each pixel 112, and the gate low voltage VGL may be a voltage that is lower than the threshold voltage of the thin film transistor TFT. The gate high voltage VGH and the gate low voltage VGL may be respectively used to determine a high level voltage and a low level voltage of a gate signal generated in the gate driver 120.

The DC-DC converter 180 may generate the power voltage AVDD using the externally supplied input voltage Vin. For example, the DC-DC converter 180 may boost the input voltage Vin, and may generate a high potential power voltage AVDD. For this, the DC-DC converter 180 may include a boosting circuit.

The power voltage AVDD generated in the DC-DC converter 180 may be supplied to the gamma reference voltage generator 150, the common voltage generator 160, the gate driving voltage generator 170, and/or the data driver 130. The power voltage AVDD is input to multiple circuit elements, and thus ripples (e.g., voltage variations) may easily occur. In particular, load changes due to changes in images displayed on the LCD panel 110 may cause ripples of the power voltage AVDD.

When there is a ripple in the power voltage AVDD, there are also ripples in gamma reference voltages VGMAR generated using the power voltage AVDD. The ripples in the gamma reference voltages VGMAR may cause cross-talk, flicker, etc. of the LCD panel 110, thereby leading to decreased picture quality.

Therefore, the gamma reference voltage generator 150 capable of generating stable gamma reference voltage VGMAR by reducing noise from the power voltage AVDD and the display device 100 having the same are provided.

In particular, provided are the gamma reference voltage generator 150, which may be formed at a relatively cheap cost and may include a noise eliminating circuit that is strong against electro-static discharge (ESD) and against electrical over stress (EDS), and the display device having the same are provided.

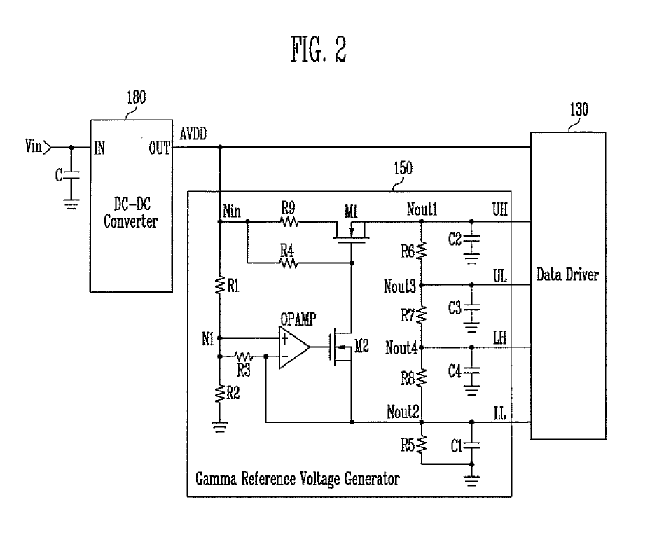

FIG. 2 is a circuit diagram of a gamma reference voltage generator in accordance with an embodiment.

Referring to FIG. 2, a gamma reference voltage generator 150 in accordance with an embodiment may receive a power voltage AVDD from a DC-DC converter 180, and may generate a plurality of gamma reference voltages UH, UL, LH, and LL.

The DC-DC converter 180 may boost an input voltage Vin input to an input terminal IN to generate the power voltage AVDD, and may output the power voltage AVDD to an output terminal OUT. Here, a stabilizing capacitor C may be included at the input terminal IN of the DC-DC converter 180.

The gamma reference voltage generator 150 may generate gamma reference voltages (e.g., the gamma reference voltages UH, UL, LH and LL) using the power voltage AVDD supplied from the DC-DC converter 180. The gamma reference voltage generator 150 may cause gamma reference voltages having a stable voltage level to be output by removing the ripples included in the power voltage AVDD.

For this, the gamma reference voltage generator 150 in accordance with an embodiment may include a first transistor M1, a second transistor M2, an operational amplifier OPAMP, first to ninth resistors R1 to R9, and first to fourth capacitors C1 to C4.

However, the gamma reference voltage generator 150 is not necessarily limited to including all of the first and second transistors M1 and M2, the operational amplifier OPAMP, the first to ninth resistors R1 to R9, and the first to fourth capacitors C1 to C4, and some of the components may be selectively included or omitted.

The first resistor R1 and the second resistor R2 may be coupled in series between an input node Nin, where the power voltage AVDD is input, and a base voltage source (e.g., ground/GND).

The third resistor R3 may be coupled between a first node N1, which is between the first resistor R1 and the second resistor R2, and a second input terminal of the operational amplifier OPAMP.

A first input terminal of the operational amplifier OPAMP may be coupled to the first node N1, the second input terminal of the operational amplifier OPAMP may be coupled to a second terminal of the third resistor R3, and the output terminal of the operational amplifier OPAMP may be coupled to a gate electrode of the second transistor M2. The first input terminal of the operational amplifier OPAMP may be a non-inverting input terminal, and the second input terminal of the operational amplifier OPAMP may be an inverting input terminal.

A first electrode of the first transistor M1 may be coupled to the input node Nin, and a second electrode of the first transistor M1 may be coupled to a first output node Nout1. The first electrode of the first transistor M1 may be directly coupled to the input node Nin, or the first electrode of the first transistor M1 may be coupled to the input node Nin via the ninth resistor R9. The first output node Nout1 may be a node through which the highest voltage among the plurality of gamma reference voltages, for example the UH gamma reference voltage, is output.

A gate electrode of the first transistor M1 may be coupled to the input node Nin via the fourth resistor R4. In an embodiment, the first transistor M1 may be implemented as a N-type MOSFET, and may be diode-connected.

The fourth resistor R4 may be coupled between the input node Nin and the gate electrode of the first transistor M1.

A first electrode of the second transistor M2 may be coupled to an access node of the gate electrode of the first transistor M1 and the fourth resistor R4. A second electrode of the second transistor M2 may be coupled to the third resistor R3 and to a second output node Nout2. The second output node Nout2 may be a node through which the lowest gamma reference voltage among the plurality of gamma reference voltages, for example the LL gamma reference voltage, is output.

A gate electrode of the second transistor M2 may be coupled to the output terminal of the operational amplifier OPAMP. In an embodiment, the second transistor M2 may be implemented as a N-type MOSFET, and may be turned on by the operational amplifier OPAMP.

The fifth resistor R5 and the first capacitor C1 may be coupled in parallel between the second output node Nout2 and the base voltage source.

The sixth resistor R6, the seventh resistor R7, and the eighth resistor R8 may be coupled in series between the first output node Nout1 and the second output node Nout2. In more detail, the sixth resistor R6 may be coupled between the first output node Nout1 and a third output node Nout3, the seventh resistor R7 may be coupled between the third output node Nout3 and a fourth output node Nout4, and the eighth resistor R8 may be coupled between the fourth output node Nout4 and the second output node Nout2.

The third and fourth output nodes Nout3 and Nout4 may be nodes through which the gamma reference voltages are output, for example the gamma reference voltages with values between those of the UH gamma reference voltage and the LL gamma reference voltage that are respectively output to the first and second output nodes Nout1 and Nout2. For example, the third output node Nout3 may be a node through which the UL gamma reference voltage is output, and the fourth output node Nout4 may be a node through which the LH gamma reference voltage is output.

The second capacitor C2 may be coupled between the first output node Nout1 and the base voltage source, the third capacitor C3 may be coupled between the third output node Nout3 and the base voltage source, and the fourth capacitor C4 may be coupled between the fourth output node Nout4 and the base voltage source.

The second, third, and fourth capacitors C2, C3, and C4 may stabilize voltages output through the first, third, and fourth output nodes Nout1, Nout3, Nout4, respectively. However, at least one capacitor may be omitted in other embodiments.

The ninth resistor R9 may be coupled between the input node Nin and the first electrode of the first transistor M1. However, the ninth resistor R9 may be omitted in an embodiment.

Hereinafter, the operations of the gamma reference voltage generator 150 in accordance with an embodiment are described.

The high potential power voltage AVDD may be input to the input node Nin. The power voltage AVDD may be input with ripples due to load changes and the like in the LCD panel 110.

The power voltage AVDD with ripples may be divided by the first and second resistors R1 and R2. The resistance values of the first and second resistors R1 and R2 may be determined by the gamma reference voltage to be output.

A resistor having very small resistance value may be used for the third resistor R3, as the resistance value of the third resistor R3 affects response speed and the gamma reference voltage output to the second output node Nout2. For example, assuming that the first and second resistors R1 and R2 and the fifth to eighth resistors R5 to R8, etc. have resistance values from approximately a few hundred Ω to approximately a few kΩ, the third resistor R3 may be designed to have a resistance of approximately a few Ω, or even about 1 or 2Ω.

Therefore, the voltage difference between two terminals of the third resistor R3 may be minute. The voltage of the second output node Nout2 may be substantially almost the same as that of the first node N1, that is, within a margin of error.

Therefore, the voltage of the first node N1 may be substantially the same voltage as the LL gamma reference voltage output through the second output node Nout2, and the resistance ratio of the first and the second resistors R1 and R2 may be set in such a way that desirable LL gamma reference voltage is output.

Many or most ripples in voltage otherwise applied to the second output node Nout2 may be eliminated by leveling actions of the first capacitor C1.

When the third resistor R3 is connected, an input voltage value input into the first input terminal of the operational amplifier OPAMP may be greater than an input voltage value of the second input terminal of the operational amplifier OPAMP, so that the second transistor M2 may be turned on. When the second transistor M2 is turned on, a voltage of the second output node Nout2 may be transferred to the gate electrode of the first transistor M1.

Here, a resistance value of the fourth resistor R4 may be set to a value that is enough to stabilize voltage and current of the second transistor M2.

When the second transistor M2 is turned on, the ripple voltage introduced to the second transistor M2 may be buffered to a drain-source voltage of the second transistor M2.

The ripples in the voltage applied to the second output node Nout2 may be eliminated by the first capacitor C1 because the power voltage AVDD has already been divided in accordance with the resistance ratio of the first and second resistors R1 and R2, and the ripple in the power voltage AVDD may be reduced. Therefore, even though the capacity of the first capacitor C1 is not designed to be relatively high, the ripples in the voltage applied to the second output node Nout2 may be effectively eliminated.

That is, as ripples are leveled by the second transistor M2 and the first capacitor C1, the voltage of the second output node Nout2 may be stabilized. Accordingly, stable LL gamma reference voltage may be output.

The first transistor M1 may be turned on in the form of diode connection. When the first transistor M1 is turned on, ripples may effectively be eliminated as the ripples in the power voltage AVDD input into the input node Nin are buffered into the drain-source voltage of the first transistor M1.

Accordingly, as the voltage free of ripples is supplied to the first output node Nout1, a stable UH gamma reference voltage may be output.

A voltage applied to a first terminal of the sixth resistor R6 may become the UH gamma reference voltage. The voltage applied to the first terminal of the sixth resistor R6 may be approximately equal to the voltage difference between the power voltage AVDD and the summation of the drain-source voltage of the first transistor M1 and the voltage applied to the ninth resistor R9, at the most.

Desirable UH, UL, LH, etc. gamma reference voltages may be obtained by adjusting respective resistance ratios of the sixth to eighth resistors R6 to R8.

The resistance value of the ninth resistor R9 may be configured to have tolerance for ESD or EOS, and may be configured in such a way that voltage division by the fifth to eighth resistors R5 to R8 may not greatly be affected. For example, the resistance value of the ninth resistor R9 may be set to approximately a few hundred Ω, for example, about 300Ω or less.

In addition, the first transistor M1, which rectifies ripples in the power voltage AVDD, may also prevent ESD or EOS from being applied to the data driver 130. Furthermore, even if ESD was introduced into the first output node Nout1, etc. during the assembly process, the data driver 130 may be protected from ESD by the fifth to eighth resistor R5 to R8 and the first to fourth capacitors C1 to C4, which are respectively coupled to the output nodes Nout1 to Nout4.

In the gamma reference voltage generator 150 in accordance with an embodiment, ripples in the LL gamma reference voltage, which has the lowest voltage among the gamma reference voltages, may be eliminated by the first capacitor C1 and the second transistor M2, and ripples in the UH gamma reference voltage, which has the highest voltage among the gamma reference voltages, may be eliminated by the first transistor M1.

Furthermore, when the UH gamma reference voltage and the LL gamma reference voltage are stabilized, the UL gamma reference voltage and the LH gamma reference voltage between the UH gamma reference voltage and the LL gamma reference voltage may also be stabilized.

Additionally, the second, third, and fourth capacitors C2, C3 and C4 may also further stabilize the voltages of the first output node Nout1, the third output node Nout3, and the fourth output node Nout4, respectively, and may prevent ESD, etc. from being introduced to the data driver 130.

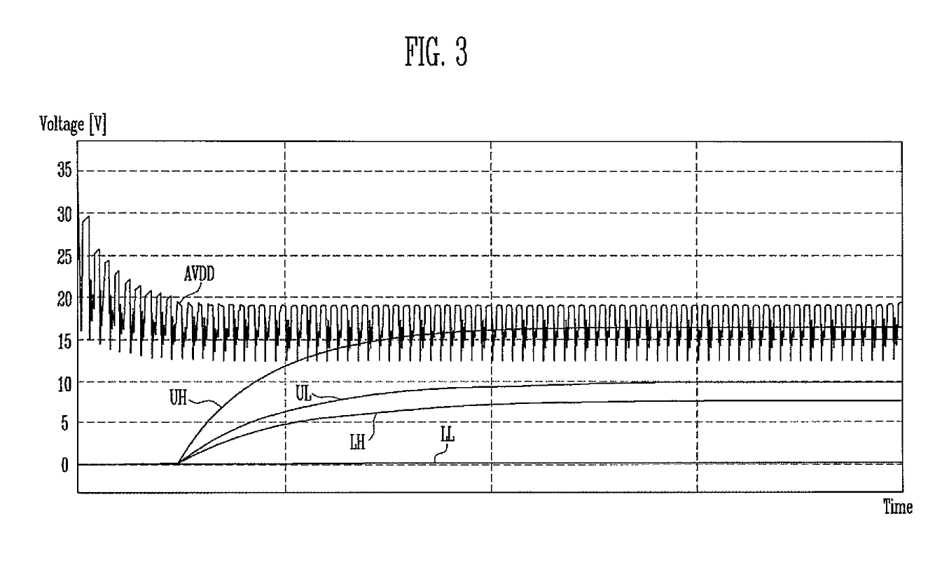

FIG. 3 is a waveform diagram illustrating input/output waveforms of the gamma reference voltage generator shown in FIG. 2. FIG. 3 illustrates changes in voltage overtime.

Referring to FIG. 3, even if ripples are formed in power voltage AVDD, the UH, UL, LH, and LL gamma reference voltages may have stable voltage level without ripples.

The ripples in the UH, UL, LH, and LL gamma reference voltages that would otherwise be generated may be more effectively eliminated by adjusting the resistance ratio between the first and second resistors R1 and R2 and by adjusting the time constants of the first to the fourth capacitors C1 to C4.

In the present embodiment, there may be provided a gamma reference voltage generator 150 including two transistors M1 and M2, an operational amplifier OPAMP, and passive elements R1 to R9 and C1 to C4, and a display device 100 having the same. The gamma reference voltage generator 150 may effectively eliminate ripples in power voltage AVDD, and may be designed in such a way that it may withstand ESD and EOS.

The gamma reference voltage generator 150 may be assembled at a relatively affordable price while effectively eliminating the ripples in the power voltage AVDD, thus generating stable gamma reference voltages VGMAR. Accordingly, cross-talk or flicker, etc. of a display panel (for example, the LCD panel 110) may be reduced or prevented, and picture quality may be improved.

In addition, the driver circuit may be protected from ESD or EOS, for example, preventing overheating or malfunction of the data driver 130. Accordingly, the display device 100 may be stably driven.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims, and their equivalents.

What is claimed is:

1. A gamma reference voltage generator comprising:
a first resistor and a second resistor coupled in series between a base voltage source and an input node for receiving a power voltage;
a third resistor comprising a first terminal coupled to a first node between the first resistor and the second resistor;
a first transistor comprising a first electrode coupled to the input node, a second electrode coupled to a first output node, and a gate electrode;
a fourth resistor coupled between the gate electrode of the first transistor and the input node;
an operational amplifier comprising a first input terminal coupled to the first node, a second input terminal coupled to a second terminal of the third resistor, and an output terminal;
a second transistor comprising a first electrode coupled to the gate electrode of the first transistor, a second electrode coupled to the second terminal of the third resistor and to a second output node, and a gate electrode coupled to the output terminal of the operational amplifier;
a fifth resistor and a first capacitor coupled in parallel between the second output node and the base voltage source; and
a plurality of resistors coupled between the first output node and the second output node.

2. The gamma reference voltage generator of claim 1, wherein the plurality of resistors comprise:
a sixth resistor coupled between the first output node and a third output node;
a seventh resistor coupled between the third output node and a fourth output node; and
an eighth resistor coupled between the fourth output node and the second output node.

3. The gamma reference voltage generator of claim 2, further comprising:
a second capacitor coupled between the first output node and the base voltage source;
a third capacitor coupled between the third output node and the base voltage source; and
a fourth capacitor coupled between the fourth output node and the base voltage source.

4. The gamma reference voltage generator of claim 1, further comprising a ninth resistor coupled between the input node and the first electrode of the first transistor.

5. The gamma reference voltage generator of claim 1,
wherein the first input terminal and the second input terminal of the operational amplifier comprise a non-inverting input terminal and an inverting input terminal, respectively, and
wherein the second transistor comprises a N-type transistor.

6. The gamma reference voltage generator of claim 1, wherein the first transistor comprises a N-type transistor.

7. The gamma reference voltage generator of claim 1,
wherein the first output node comprises a node through which a gamma reference voltage comprising a highest voltage among a plurality of gamma reference voltages is configured to be output, and
wherein the second output node comprises a node through which a gamma reference voltage comprising a lowest voltage among the plurality of gamma reference voltages is configured to be output.

8. A display device comprising:
a gamma reference voltage generator configured to generate a plurality of gamma reference voltages using a power voltage;
a data driver configured to generate data signals using the gamma reference voltages; and
a display panel configured to display images corresponding to the data signals,
wherein the gamma reference voltage generator comprises:
a first resistor and a second resistor coupled in series between a base voltage source and an input node for receiving a power voltage;
a third resistor comprising a first terminal coupled to a first node between the first resistor and the second resistor;
a first transistor comprising a first electrode coupled to the input node, a second electrode coupled to a first output node, and a gate electrode;
a fourth resistor coupled between the gate electrode of the first transistor and the input node;
an operational amplifier comprising a first input terminal coupled to the first node, a second input terminal coupled to a second terminal of the third resistor, and an output terminal;
a second transistor comprising a first electrode coupled to the gate electrode of the first transistor, a second electrode coupled to the second terminal of the third resistor and to a second output node, and a gate electrode coupled to the output terminal of the operational amplifier;
a fifth resistor and a first capacitor coupled in parallel between the second output node and the base voltage source; and
a plurality of resistors coupled between the first output node and the second output node.

9. The display device of claim 8, wherein the plurality of resistors comprise:
a sixth resistor coupled between the first output node and a third output node;
a seventh resistor coupled between the third output node and a fourth output node; and
an eighth resistor coupled between the fourth output node and the second output node.

10. The display device of claim 9, wherein the gamma reference voltage generator further comprises:
a second capacitor coupled between the first output node and the base voltage source;
a third capacitor coupled between the third output node and the base voltage source; and
a fourth capacitor coupled between the fourth output node and the base voltage source.

11. The display device of claim 8, wherein the gamma reference voltage generator further comprises a ninth resistor coupled between the input node and the first electrode of the first transistor.

12. The display device of claim 8, wherein the first transistor and the second transistor comprise N-type transistors.
